(19) United States
(12) Patent Application Publication
(10) Pub. No.: US 2018/0303285 A1
(43) Pub. Date: Oct. 25, 2018

(54) AIR FRYER

(71) Applicant: FOSHAN SHUNDE KUFU ELECTRIC APPLIANCES CO., LTD., Foshan (CN)

(72) Inventor: Xiao Cheng, Foshan (CN)

(21) Appl. No.: 15/834,045

(22) Filed: Dec. 6, 2017

(30) Foreign Application Priority Data
Apr. 21, 2017 (CN) 201710267445.X

(51) Int. Cl. A47J 37/06; A47J 36/06; A47J 36/16

(52) U.S. Cl. CPC A47J 37/0641; A47J 36/16; A47J 36/06

(57) ABSTRACT

The present invention discloses an air fryer, which comprises a fryer housing, a first chamber and a second chamber, wherein the first chamber is communicated with the second chamber, a bottom of the first chamber is provided with an air exhaust and a top of the second chamber is provided with an air intake; a heating element, which is arranged in the second chamber; a cross flow fan, which is located in the second chamber, wherein the cross flow fan comprises an impeller with a horizontal axis, and when the cross flow fan is in operation, air passes through the air intake horizontally and exits the air exhaust horizontally. The air fryer disclosed in the present invention is able to enhance the thermal cycle efficiency and the food could be heated even, crispy and tasting good.

### CROSS REFERENCE TO RELATED APPLICATIONS

The present application claims the benefit of Chinese Patent Application No. 201710267445.X filed on Apr. 21, 2017, the entire contents of which are hereby incorporated by reference.

### FIELD OF THE INVENTION

The present invention relates to an air fryer.

### BACKGROUND OF THE INVENTION

There are two types of air fryers available in the current market.

The first type is drawer air fryers, which are characterized in that a heating element and an air circulation system are arranged on top while a food basket is provided beneath the heating element and the air circulation system. In this manner, the heat produced by the heating element is entirely forced down by the air circulation system to generate heated air from top to bottom circulating around all 360 degrees of the food. This however results in the whole thermal cycle efficiency staying low and different heating temperature being received by every part of the food, especially the bottom of the food being toasted insufficiently. Even oil coverage could be accomplished through lifting the food basket manually and shaking continuously, which gives rise to inconvenient operation and brings undesired experience. Meanwhile, due to the uneven air temperature staying in the cooking chamber, water vapor is generated rendering the food lacking crispy quality or good taste.

The second type is horizontal air fryers, which are characterized in that a food chamber is arranged with an air circulation system and a heating element side by side. The heating element is installed on the way of the air intake or the exhaust of the air circulation system, which causes the heat produced by the heating element being entirely forced through from one side to another side circulating around all 360 degrees of the food. Such arrangement gives higher thermal cycle efficiency as compared with drawer air fryer; the surface of the food however fails to be heated evenly, especially the bottom of the food and the distant part of the food from the air circulation system. For realizing even heating of every single part of the food, manually shaking the food basket is also in need, which gives rise to inconvenient operation and undesired experience. Meanwhile, due to the uneven air temperature and air pressure staying in the cooking chamber, water vapor is generated rendering the food lacking crispy quality or good taste.

Chinese patent No. 201410802286.5 disclosed an air fryer, which comprises a fryer body, liner, frying basket provided within the liner, electrical heating tube arranged above the frying basket and fan located above the heating tube. Side wall of the frying basket is thin plate and bottom of the frying basket is grid. Air channel is provided between the liner and the frying basket. Swirl guide cylinder is provided externally at the bottom of the frying basket and is connected with the side wall of the frying basket. Air inlets for forming rotary air flow are opened on the bottom of the swirl guide cylinder. The air inlets divert the air flow in the same direction and from a swirl. The air fryer disclosed in the invention has simple structured frying basket, easily manufactured and easily cleaned liner, and frying basket that is better supported. However the air fryer of this invention is a drawer air fryer, therefore works in low thermal cycle efficiency.

Chinese patent No. 201410103680.X disclosed an air fryer, which comprises a fryer rack, a fryer body, a cover and a base. The fryer body is located in the fryer rack which is located in the base, and one end of the cover is hinged to the tail of the fryer rack while the other end of the cover is connected with the front of the fryer rack in an openable and closable manner. The air fryer further comprises a hot air circulation structure which comprises an axial flow fan, a wire heater and a hot air passage, the axial flow fan is mounted in the front of the fryer rack, an axial air suction opening of the axial flow fan is located in a hole between the fryer body and the fryer rack, a radial air outlet of the axial flow fan is communicated with an outlet at the bottom of the hot air passage which is disposed vertically and located in the cover, the outlet of the hot air passage is horizontal in direction and communicated with an inner cavity of the fryer body, and the wire heater is located in the hot air passage. The air fryer disclosed in this invention is capable of effectively lowering power consumption and high in heat efficiency, however it fails to solve the problem of uneven heating of the food.

### SUMMARY OF THE INVENTION

The present invention aims at providing an air fryer in order to solve the drawbacks of current technology. So that the thermal cycle efficiency could be enhanced and the food could be heated homogeneously, crispy and tasting good.

The present invention provides an air fryer for realizing the above-mentioned purpose, which comprises:
a fryer housing, which comprises a first chamber and a second chamber. The first chamber is communicated with the second chamber. A bottom of the first chamber is provided with an air exhaust and a top of the second chamber is provided with an air intake;
a heating element, which is arranged in the second chamber;
a cross flow fan, which is located in the second chamber. The cross flow fan comprises an impeller with a horizontal axis. When the cross flow fan is in operation, air passes through the air intake horizontally and exits the air exhaust horizontally.

In the present invention, the first chamber is used for containing food and the second chamber is used for storing the heating element and the cross flow fan. The air exhaust and the air intake are used for forming a cycle channel for hot air. The heating element is used for heating the food. The cross flow fan and the cycle channel formed by the air intake and the air exhaust are used for efficient circulation of the heat produced by the heating element.

In the present invention, the cross flow fan has wide passage and produces large air flow. The adoption of the cross flow fan enables the thermal cycle in the air fryer running faster and reduces noises effectively.

As compared with prior art, the air fryer disclosed in the present invention enhances thermal cycle efficiency due to its arrangement of the first chamber, the second chamber, the heating element and the cross flow fan provided in the second chamber, and the first chamber being communicated with the second chamber. Disposing the cross flow fan horizontally allows air passing in the air intake horizontally and exiting the air exhaust horizontally, makes the hot air in the first chamber that used for containing the food well-distributed, thus produces even heating on the surface of the food, prevents generation of water vapor due to air temperature difference, and renders the food crispy and tasty.

In another embodiment of the present invention, the heating element comprises a first heater. The first heater is arranged at the air exhaust and specifically between the air exhaust and the cross flow fan.

In the present invention, the first heater is used for heating up the air in the air fryer and air blown out of the cross flow fan. The air, being heated by the first heater, runs through the air exhaust located at the bottom of the first chamber into the first chamber to heat the food contained in the first chamber.

In another embodiment of the present invention, the heating element further comprises a second heater and the second heater is arranged at the air intake.

In the present invention, the second heater is further used for heating up the air in the air fryer. The second heater heats up the air that passes through the air intake located at the top of the second chamber and releases the air into the cross flow fan. Through the installation of the second heater in the second chamber of the air fryer, the air in the air fryer keeps being heated evenly, the air temperature difference in the air fryer is reduced, thus makes the food golden-brown and crispy.

In an embodiment of the present invention, the air fryer further comprises a food tray and the food tray is removable in the first chamber.

In the present invention, the food tray is used for containing the food. Being removable, the food tray is convenient to take out and clean.

In another embodiment of the present invention, there is at least one food tray, and each food tray is disposed in the first chamber above or beneath one another. Each food tray is provided with a plurality of air vents and the air vents are distributed as an order array.

In an embodiment of the present invention, the cross flow fan further comprises a wind deflector. The wind deflector comprises an upper wind deflector and a lower wind deflector. The upper wind deflector faces the air intake and the lower wind deflector faces the air exhaust.

In another embodiment of the present invention, the air fryer further comprises a drip cup. The drip cup is detachably arranged in the first chamber and under the food tray. A bottom of the drip cup and its surface are provided with a plurality of bumps.

In the present invention, the bumps provided on the bottom and surface of the drip cup are used for reflecting the air contained in the air fryer so that ensures the heating temperature remaining high and even.

In the present invention, the bumps that are provided on the bottom and surface of the drip cup may be shaped in any forms.

In an embodiment of the present invention, the air fryer further comprises a lid. The lid is detachably connected to the fryer housing. The lid further comprises a lid lining. The lid lining is arranged in the lid and a lower surface of the lid lining is provided with a plurality of bumps.

In the present invention, the bumps provided on the lower surface of the lid lining are used for reflecting the air contained in the air fryer so that ensures the heating temperature remaining high and even.

In the present invention, the bumps that provided on the lower surface of the lid lining may be shaped in any forms.

In an embodiment of the present invention, the air fryer further comprises a roller container. The roller container is detachably arranged in the first chamber.

In the present invention, the roller container is used for containing the food. A surface of the roller container is covered with a plurality of through holes for hot air running through to heat the food. The roller container may be shaped in any forms, including cylindrical, column-shaped.

In an embodiment of the present invention, the air fryer further comprises a rotating system. The rotating system is arranged on a side face of the air fryer and the rotating system is connected to the roller container.

In the present invention, the rotating system is used for propelling the roller container to rotate. The rotating system comprises a motor and a transmission system. The transmission system includes a driving wheel mechanical linkage, a synchronous belt, a gear, or a turbine worm. The adoption of the rotating system propels the roller container to rotate automatically, which frees the hands of users and gives them a favorable experience. Meanwhile such design gives the food even heating and renders satisfying golden-brown.

The beneficial effect of the present invention is that the temperature stays high and even in the air fryer through arranging the first heater and the second heater respectively at the air exhaust and the air intake. The adoption of two heaters gives rise to a second heating of the hot circulating air, which effectively reduces water vapor in the hot circulating air, renders the food golden-brown and crispy. The adoption of the cross flow fan enables the thermal circulation in the air fryer faster and effectively reduces noises. The bumps arranged on the bottom of the drip cup and each surface and the lower surface of the lid lining reflect the air contained in the air fryer so that ensures the heating temperature remaining high and even.

Embodiments of the present invention are further explained clearly as follows in conjunction with figures. The above-mentioned embodiments are the preferred embodiments of the present invention. Variations and modifications are allowed within the scope of the invention. Those skilled in the art will appreciate that the features described above can be combined in various ways to form multiple variations of the invention. As a result, such variations fall within the scope of the protection to the present invention.

### BRIEF DESCRIPTION OF THE DRAWINGS

FIG. 1 is a longitudinal sectional view of an air fryer according to the first embodiment of the present invention.

FIG. 2 is a schematic view of the air fryer according to the first embodiment of the present invention.

FIG. 3 is a schematic view of a food tray according to the first embodiment of the present invention.

FIG. 4 is an exploded view of the air fryer according to the second embodiment of the present invention.

### DETAILED DESCRIPTION OF ILLUSTRATED EMBODIMENTS

### Embodiment 1

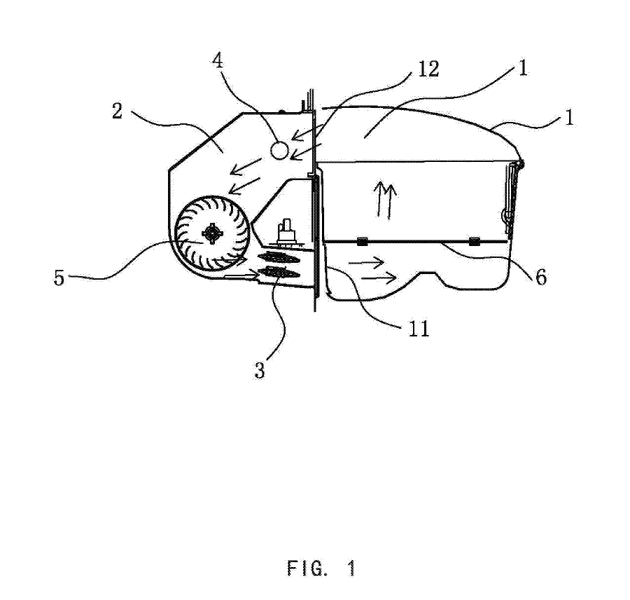

As shown in FIG. 1, a longitudinal section view of an air fryer provided in the present embodiment, the air fryer comprises a first chamber 1, a second chamber 2, a first heater 3, a second heater 4, a cross flow fan 5, a food tray 6, a drip cup (not shown in figures) and a lid 7.

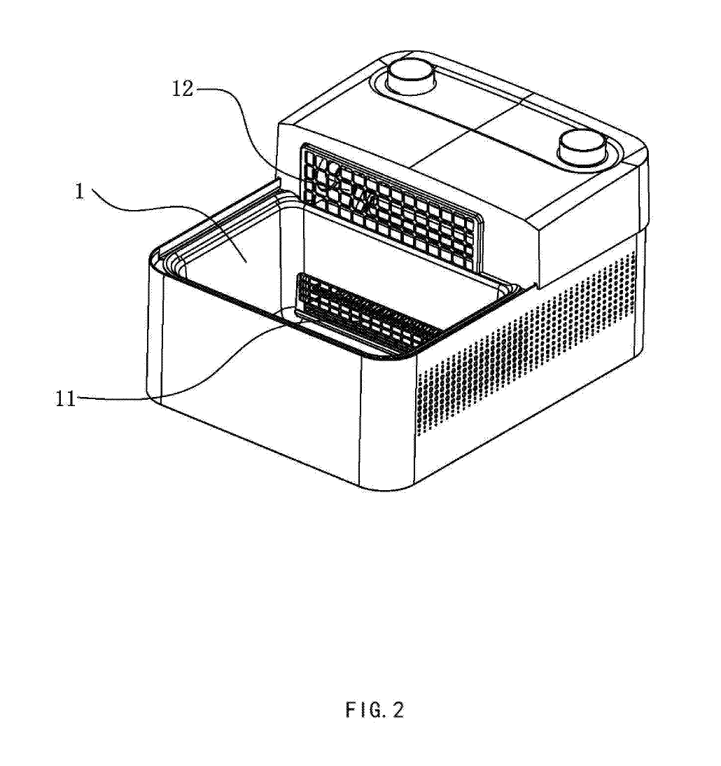

As shown in FIG. 2, a schematic view of the air fryer provided in the present embodiment, a bottom of the first chamber 1 is provided with an air exhaust 11 and a top of the second chamber 2 is provided with an air intake 12. The first chamber 1 is communicated with the second chamber 2 via the air exhaust 11 and the air intake 12. The first chamber 1 is used for containing the food and the second chamber 2 is used for storing the first heater 3, the second heater 4, the cross flow fan 5 and a hot air cycle channel is formed between the air exhaust 11 and the air intakel2.

In the present embodiment, the cross flow fan 5 is located horizontally in the second chamber 2. The cross flow fan 5 comprises a wind deflector, which includes an upper wind deflector and a lower wind deflector. The upper wind deflector faces the air intake 12 and the lower wind deflector faces the air exhaust 11. The cross flow fan 5 has wide passage and produces large air flow. The adoption of the cross flow fan 5 enables the thermal cycle in the air fryer running faster and reduces noises effectively.

In the present embodiment, the first heater 3 is arranged at the air exhaust 11 and specifically between the air exhaust 11 and the cross flow fan 5. The second heater 4 is arranged at the air intake 12. The first heater 3 is used for heating up the air in the air fryer and air blown out of the cross flow fan 5. The air, being heated by the first heater 3, runs through the air exhaust 11 into the first chamber 1 to heat the food contained in the first chamber 1. The second heater 4, working as an ancillary heating element, is further used for heating up the air in the air fryer. The second heater 4 heats up the air that passes through the air intake 12 then runs into the second chamber 2 and releases the air into the cross flow fan 5. Through the installation of the second heater 4 in the second chamber 2 of the air fryer, the air in the air fryer keeps being heated evenly, the air temperature difference in the air fryer is reduced, thus makes the food golden-brown and crispy.

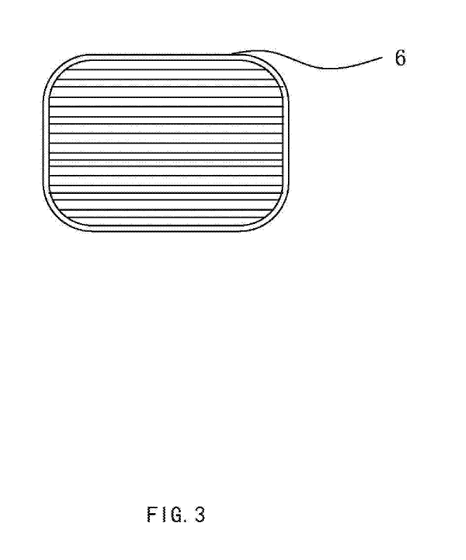

As shown in FIG. 3, a schematic view of the food tray provided in the present embodiment, the food tray 6 is removable in the first chamber 1. There is at least one food tray 6, and each food tray 6 is able to move up and down in the first chamber 1. Each food tray 6 is provided with a plurality of bar-shaped air vents and the air vents are distributed as an order array. The food tray 6 is used for containing the food. Being removable, the food tray 6 is convenient to take out and clean.

In the present embodiment, the drip cup is detachably arranged in the first chamber 1 and under the food tray 6. A bottom of the drip cup and its surface are provided with a plurality of bumps. The lid 7 is detachably connected to a fryer housing. The lid 7 further comprises a lid lining. A lower surface of the lid lining is provided with a plurality of bumps. The bumps provided on the bottom and surface of the drip cup and the bumps provided on the lower surface of the lid lining are used for reflecting the air contained in the air fryer so that ensures the heating temperature remaining high and even.

The temperature stays high and even in the air fryer provided in the present embodiment through arranging the first heater 3 and the second heater 4 respectively at the air exhaust 11 and the air intake 12. The adoption of two heaters gives rise to a second heating of the hot circulating air, which effectively reduces water vapor in the hot circulating air, renders the food golden-brown and crispy. The adoption of the cross flow fan 5 enables the thermal circulation in the air fryer faster and effectively reduces noises. The bumps arranged on the bottom of the drip cup and each surface and the lower surface of the lid lining reflect the air contained in the air fryer so that ensures the heating temperature remaining high and even.

### Embodiment 2

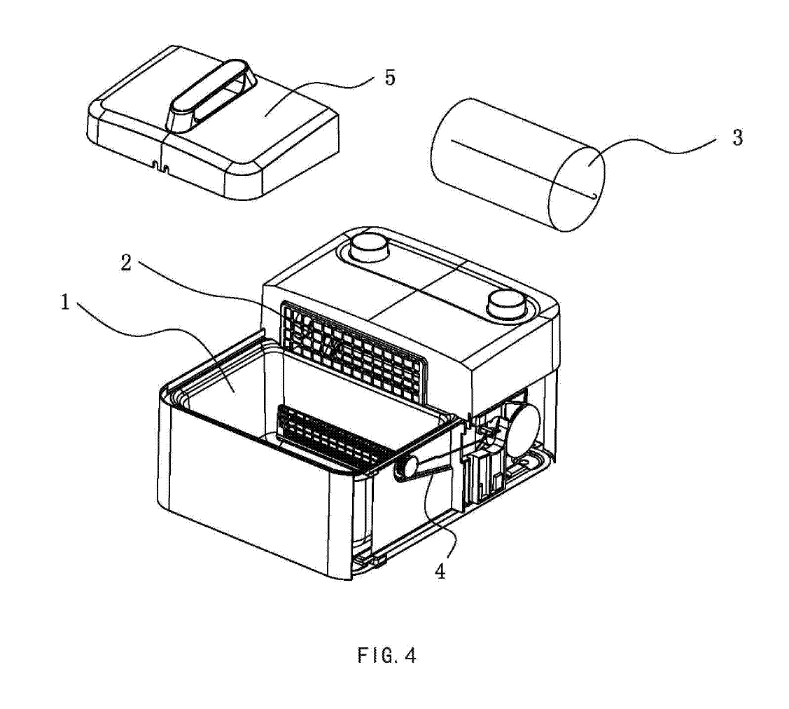

As shown in FIG. 4 is a schematic view of the air fryer provided in the present embodiment. The air fryer comprises a first chamber 1, a second chamber 2, a heating element (not shown in figures), a cross flow fan (not shown in figures), a roller container 3, a rotating system 4, a drip cup (not shown in figures) and a lid 5. The distinction between the present embodiment and the first embodiment is the adoption of the roller container 3 rather than the food tray and the adoption of the rotating system 4 for propelling the roll container 3 to rotate.

In the present embodiment, the roller container 3 is detachably arranged in the first chamber 1. The roller container 3 is cylindrical. A surface and two axial ends are covered with a plurality of through holes and the through holes are distributed as an order array. The roller container 3 is used for containing the food. Being detachable, the roller container 3 is convenient to take out and clean while the air fryer is in operation for cooking the food. In other embodiments, the roller container 3 may be shaped in any desired forms, not limitation is attached here.

In the present embodiment, the rotating system 4 is arranged on a side face of the air fryer and is connected to the roller container 3 for propelling the roller container 3 to rotate. The rotating system 4 comprises a motor, a synchronous belt, a main and an ancillary synchronizing wheel.

The air fryer disclosed in the present embodiment adopts the roller container as a container during the processing of the food and also adopts the rotating system 4 to propel the roller container to rotate automatically, which frees the hands of users and gives them a favorable experience. Meanwhile such design gives the food even heating and renders satisfying golden-brown.

The above-mentioned embodiments are the preferred embodiments of the present invention and are considered in all respects as illustrative and not restrictive. Variations and modifications are allowed within the scope of the invention. Those skilled in the art will appreciate that the features described above can be combined in various ways to form multiple variations of the invention. As a result, such variations fall within the scope of the protection to the present invention.

What is claimed is:

1. An air fryer, comprising:
a fryer housing, which comprises a first chamber and a second chamber; the first chamber is communicated with the second chamber; a bottom of the first chamber is provided with an air exhaust and a top of the second chamber is provided with an air intake;
a heating element, which is arranged in the second chamber;
a cross flow fan, which is located in the second chamber; the cross flow fan comprises an impeller with a horizontal axis; when the cross flow fan is in operation, air passes through the air intake horizontally and exits the air exhaust horizontally.

2. The air fryer according to claim 1, characterized in that the heating element comprises a first heater, which is arranged at the air exhaust and specifically between the air exhaust and the cross flow fan.

3. The air fryer according to claim 2, characterized in that the heating element further comprises a second heater and the second heater is arranged at the air intake.

4. The air fryer according to claim 1, characterized in that the air fryer further comprises a food tray and the food tray is removable in the first chamber.

5. The air fryer according to claim 4, characterized in that there is at least one food tray, and each food tray is disposed in the first chamber above or beneath one another. Each food tray is provided with a plurality of air vents and the air vents are distributed as an order array.

6. The air fryer according to claim 1, characterized in that the cross flow fan further comprises a wind deflector, which comprises an upper wind deflector and a lower wind deflector; the upper wind deflector faces the air intake and the lower wind deflector faces the air exhaust.

7. The air fryer according to claim 1, characterized in that the air fryer further comprises a drip cup, which is detachably arranged in the first chamber and under the food tray; a bottom of the drip cup and its surface are provided with a plurality of bumps.

8. The air fryer according to claim 1, characterized in that the air fryer further comprises a lid, which is detachably connected to the fryer housing; the lid further comprises a lid lining, which is arranged in the lid and a lower surface of the lid lining is provided with a plurality of bumps.

9. The air fryer according to claim 1, characterized in that the air fryer further comprises a roller container and the roller container is detachably arranged in the first chamber.

10. The air fryer according to claim 9, characterized in that the air fryer further comprises a rotating system, which is arranged on a side face of the air fryer and the rotating system is connected to the roller container.

11. The air fryer according to claim 2, characterized in that the air fryer further comprises a food tray and the food tray is removable in the first chamber.

12. The air fryer according to claim 3, characterized in that the air fryer further comprises a food tray and the food tray is removable in the first chamber.

13. The air fryer according to claim 11, characterized in that there is at least one food tray, and each food tray is disposed in the first chamber above or beneath one another. Each food tray is provided with a plurality of air vents and the air vents are distributed as an order array.

14. The air fryer according to claim 12, characterized in that there is at least one food tray, and each food tray is disposed in the first chamber above or beneath one another. Each food tray is provided with a plurality of air vents and the air vents are distributed as an order array.

15. The air fryer according to claim 2, characterized in that the air fryer further comprises a lid, which is detachably connected to the fryer housing; the lid further comprises a lid lining, which is arranged in the lid and a lower surface of the lid lining is provided with a plurality of bumps.

16. The air fryer according to claim 3, characterized in that the air fryer further comprises a lid, which is detachably connected to the fryer housing; the lid further comprises a lid lining, which is arranged in the lid and a lower surface of the lid lining is provided with a plurality of bumps.
